(19) United States
(12) Patent Application Publication
(10) Pub. No.: US 2007/0143660 A1
(43) Pub. Date: Jun. 21, 2007

(54) System and method for indexing image-based information

(76) Inventors: John M. Huey, Rome, GA (US); C. Michael Cooper, Norcross, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/311,012

(22) Filed: Dec. 19, 2005

(51) Int. Cl. G06F 17/30; G06F 17/00

(52) U.S. Cl. 715/500; 707/3

(57) ABSTRACT

An information processing system comprises an image acquisition device, a workstation, and a data store. The image acquisition device generates a representation of a source item. The workstation includes a rendering device which presents an application interface, an input device that provides a source identifier, logic that retrieves a set in accordance with the source identifier, a screen scraper that captures information responsive to the set and logic that associates the information with the representation.

### BACKGROUND OF THE INVENTION

1. Field of the Invention

This invention relates generally to the field of document image processing to produce digital images for later retrieval. More specifically this invention relates to a collection and distribution system for making document images available to a variety of geographically distributed users.

2. Related Art

The use of a computer based image processing system or architecture to scan documents such as checks and the like, and to then digitally store the results on mass storage devices is generally known in the art.

U.S. Pat. No. 4,888,812, discloses such a check processing system that is based upon a high-speed document reader/sorter wherein features such as feeding checks to an image scanner, monitoring image quality and possibly interrupting the process as a result of poor image quality, image data compression, image resolution control, parallel processing of image data, and storage of check images on both high-speed and low-speed mass storage devices such as magnetic storage and optical storage are provided.

A number of document management systems also provide for the integration, storage, and later retrieval of a captured image. Generally, the integration mechanism is an identification field derived from information pertinent to the image acquisition process. Some systems identify acquired images based on the location, date, time or any combination of these time—space related identifiers. Other systems identify the image by associating a serial number indexed to a seed or primary value with the image information. Sometimes an identifier associated with the image acquisition device is included in information used to identify the image.

It is common practice in the healthcare industry for healthcare service providers to record information that identifies the patient, the patient's medical insurance coverage, or other patient specific items at the point-of-service. The process of recording information may include generating a copy of a patient's medical insurance card to include in a paper file at the point-of-service. However, a paper copy in a file folder at the point-of-service cannot be used by a medical claim processor located remotely from the point-of-service.

Document management systems can use network infrastructures to deliver document images to internal and external users. Absent from these document management systems is a mechanism for efficiently exposing information available on the images to users of the document management systems. Accordingly, despite the capabilities provided by document management systems to store image information there is still a need for improved systems and methods that expose image information to users that desire image-based information.

### SUMMARY

Embodiments of an information processing system comprise an image acquisition device and a workstation. The image acquisition device is configured to generate a representation of a source item. The workstation comprises an input device, logic that retrieves a set, a rendering device, a screen scraper, and logic that associates. The input device provides a source identifier. The logic that retrieves a set is responsive to the source identifier. The rendering device renders an interface responsive to a point-of-service application. The screen scraper captures information from the interface in response to the set. The logic that associates, indexes the representation with the screen scraped information.

The information processing system can be coupled with a network to expose the representation (i.e., image information) to a user of the system with access privileges that generates a query that matches at least a portion information associated with the representation.

Related methods of operation are also provided. An exemplary method for indexing image-based information in a document management system comprises the steps of acquiring a representation of a source item at a point-of-service, identifying a type responsive to the source item, identifying a set of one or more members responsive to the type, using an interface at the point-of-service to acquire information to populate a data field associated with a member of the set, associating information in the data field with the representation and using the information to expose the source item to a user of the document management system that communicates a query matching at least a portion of the information.

Other systems, methods, features, and advantages will be or become apparent to one skilled in the art upon examination of the following figures and detailed description. All such additional systems, methods, features, and advantages are within the scope of this description as defined in the accompanying claims.

### BRIEF DESCRIPTION OF THE FIGS.

The systems and methods for integrating image-based information can be better understood with reference to the following figures. The components within the figures are not necessarily to scale, emphasis instead being placed upon clearly illustrating principles of operation of the system and method for indexing image information. Moreover, in the figures, like reference numerals designate corresponding parts throughout the different views.

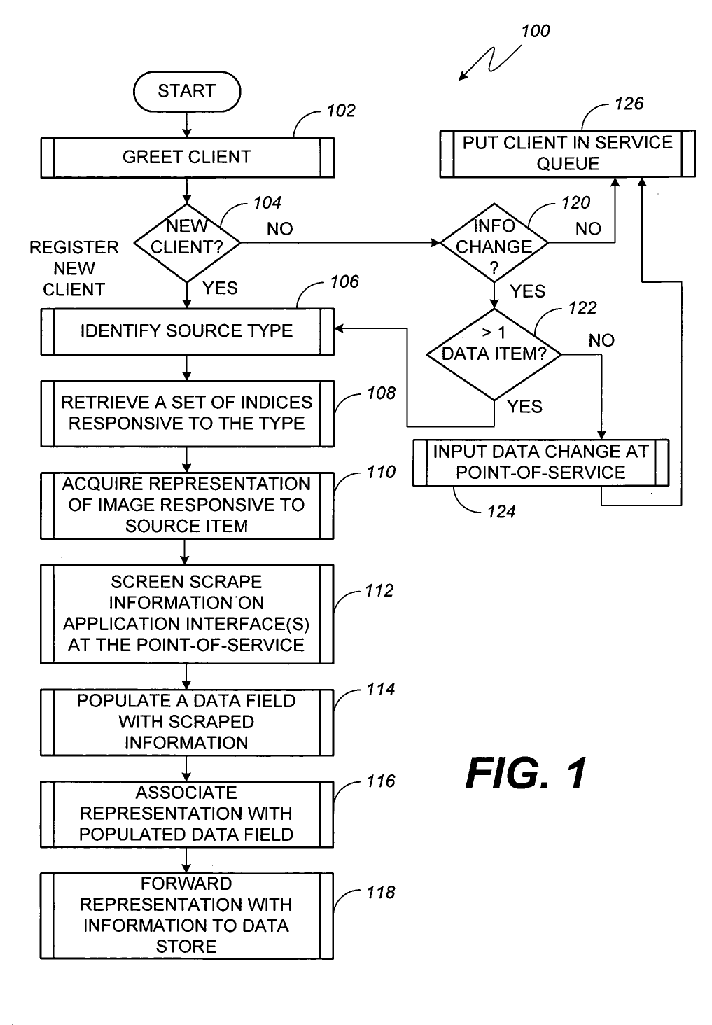

FIG. 1 is a flow diagram illustrating an exemplary method for processing clients at a point-of-service.

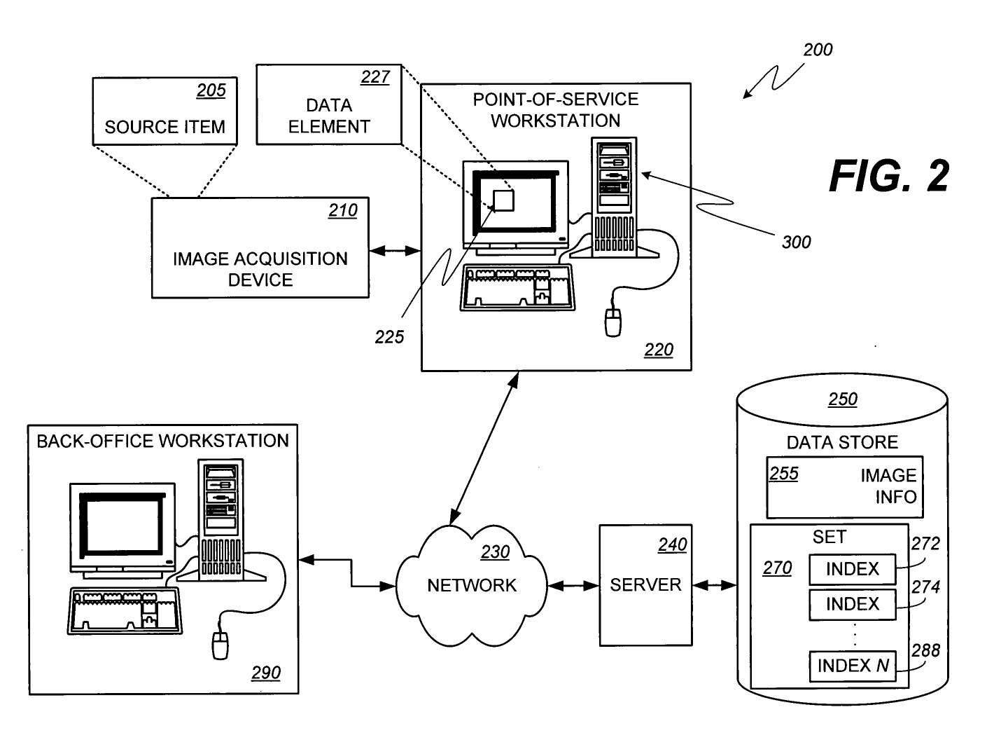

FIG. 2 is a schematic diagram illustrating an embodiment of an information processing system that can implement some of the steps of the method of FIG. 1.

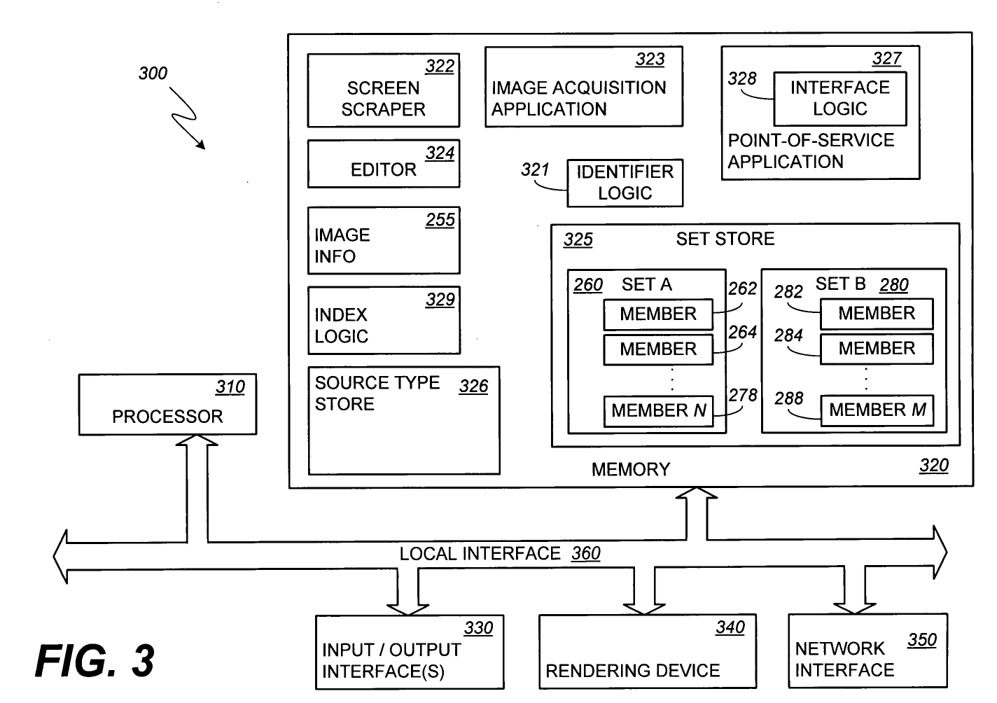

FIG. 3 is a block diagram illustrating an embodiment of the computing device of FIG. 2.

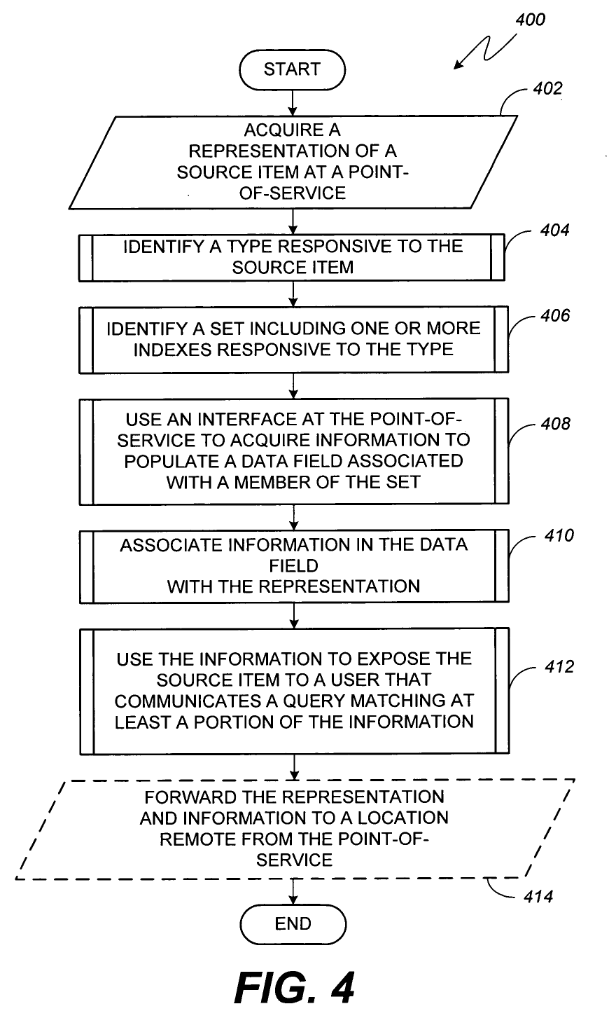

FIG. 4 is a flow diagram illustrating an embodiment of a method for indexing image-based information that can be implemented by the information processing system of FIG. 2.

### DETAILED DESCRIPTION

Although described with particular reference to registering and serving patients in a medical office or health care service environment, the systems and methods for indexing image-based information are not so limited and can be applied or otherwise implemented in a number of document management environments.

The systems and methods for indexing image-based information apply or otherwise associate an index at the point-of-service with a representation or image of a source item. The index is derived from an application interface operable at the point-of-service at the time the image information is acquired. The source item can be a completed questionnaire, a medical insurance card, a state issued driver's license, or any of a number of different items. An information processing system identifies the source item as belonging to one of a number of different source types. The source type is used by the system to identify a corresponding set that includes text information that can be observed on one or more interfaces typically rendered on a display device coupled to a workstation in use at the point-of-service. The set can include information about one or more interfaces. The information can be used by a screen scraper to collect appropriate information for populating data fields associated with one or more members of the set. Once a field is populated with data and associated with the representation, communicatively coupled users of a document management system with appropriate access credentials can query a data store to access the representation of the source item. In this manner, the representation can be controllably exposed in near real time to back-office claims processors or others with a need to observe a representation of the source item.

While an operator is accessing a representation of the source item, there will typically be additional applications operative on the operators' workstation. These other applications include other information that can be used to populate data fields associated with one or more members in the set. Once the source type has been identified, a source type identifier is used to retrieve or otherwise identify a particular set associated with the identified source type. The set along with information about rendered interfaces associated with the additional applications (e.g., where a particular data element or field can be found on a respective interface) is used to direct a screen scraper, which acquires text information from the rendered representation. The acquired text information can then used to populate the various data fields in the various applications that require the corresponding information. The acquired text is also used to populate one or more data values associated with indexes that are further associated with the image information. This index data is captured and associated with the underlying image information without the operator entering the additional index data thus improving the efficiency of the image data indexing task and form completion at the point-of-service.

Turning now to the drawings which present representative embodiments of the systems and methods for indexing image-based information, FIG. 1 is a flow diagram illustrating an exemplary method 100 for processing clients at a point-of-service. Method 100 begins with block 102 where a client arrives and is greeted at a point-of-service. Next, a determination is made as indicated in query 104, whether the client is new to the service provider. When the client is not new to the service provider, as indicated by the flow control arrow labeled “NO,” exiting query 104, query 120 is performed to determine if any important information has changed regarding the client. When there has been no change to any important information related to the client, as indicated by the flow control arrow labeled “NO,” exiting query 120, the client is placed in the service queue as indicated by block 126. When there has been a change with important information related to the client, as indicated by the flow control arrow labeled “YES,” exiting query 120, query 122 is performed to determine if a single data item has changed. When only a single data item has changed, as shown by the flow control arrow labeled “NO,” exiting query 122, an operator at the point-of-service may enter the data, as shown in block 124. Otherwise, when two or more data items have changed, as shown by the flow control arrow labeled “YES,” exiting query 122, processing continues with block 106. In the example embodiment, two or more changed data items result in the information processing system responding in manner described below. It should be understood that the system and method for indexing image-based information is not so limited. The system and method can be enabled upon the occurrence of other thresholds or can be enabled each time a client is processed at the point-of-service as may be desired.

When the client is new to the service provider, as indicated by the flow control arrow labeled “YES,” exiting query 104, or when it is desired to update two or more data items regarding a client as indicated by the flow control arrow labeled, “YES,” exiting query 122, a source type for an item associated with the client is identified as indicated in block 106. More particularly, a source type is identified. A source item can take the form of a new medical insurance card, a government issued identification card, a completed questionnaire, or other items that contain provider desired information. Thereafter, as shown in block 108, a set including one or more indexes is retrieved in accordance with the source type. The set is predetermined and will generally be configured by the service provider. The set includes one or more elements of interest that are typically discoverable on an application interface that is often active on a point-of-service workstation.

In block 110, a representation (e.g., image information) of the source item is acquired. Substantially concurrently therewith or at any time subsequent to the function of block 110 being completed, an application interface is rendered (e.g., an application interface presented on a display device to an operator of a client application) at the point-of-service. For example, it is often the case that a greeter enters one or more client identifiers via an input device associated with a workstation or other computing device. The client identifier can be used to query a client database. This represents one way to perform query 104. Typically, the client database information is exposed via a workstation interface that is rendered on a display device. When the greeter is processing a returning client, the rendered data includes one or more client specific data elements (e.g., name, address, insurance provider, group number, level of coverage) some of which may be presented in a machine readable or encoded format. In block 112, a screen scrape is applied against one or more application interfaces at the point-of-service. A screen scrape is an automated process that identifies and extracts one or more data elements observable on an application interface. In an example embodiment, the screen scrape is applied to an application interface at the point-of-service. Although a screen scrape process could be applied against additional interfaces rendered at the point-of-service.

Thereafter, as indicated in block 114, a data field is populated with information provided by the screen scrape. As shown in block 116, image information is associated with the populated data field. At this point, the representation or image can be identified via the association with the screen scraped information from the data field. In accordance with one embodiment of the system, one or both of the image information and the populated data field are forwarded to a data store that is accessible to users of the system that are not in the immediate vicinity of the point-of-service, as indicated in block 118. Those skilled in the art will understand that the data store can be coupled and accessible via a local area network (e.g., within a single building or complex of buildings) or a wide area network.

When the client is serviced at a facility that provides medical services, access to the network, the various applications operative on network coupled resources and the image information that results from scanning or otherwise acquiring a representation of a source item are protected by controlling access to the network resources. An additional layer of security can be provided by controlling user access to information in one or more databases or information stored in individual files.

Thus, any communicatively coupled computing device configured with appropriate software and access credentials can communicate a message or query including one or more of the populated data fields or a portion of the information within one or more of the populated data fields to identify, access, retrieve, render, and observe representations of any source item acquired and stored in the data store.

FIG. 2 is a schematic diagram illustrating an embodiment of an information processing system 200 that can be used to implement the method 100 introduced and described in association with the flow diagram FIG. 1. Information processing system 200 comprises point-of-service devices coupled via network 230 to back-office workstation 290, server 240, and data store 250. Point-of-service devices include image acquisition device 210 and point-of-service workstation 220.

As illustrated in FIG. 2, source item 205 is scanned, photographed, or otherwise acquired by image acquisition device 210, which is communicatively coupled to point-of-service workstation 220. Point-of service workstation 220 comprises a computing device 300, a display device, and one or more human-machine input devices, such as a keyboard and a mouse. The computing device 300, which will be further explained in greater detail with respect to FIG. 3, comprises a central processing unit, memory, and input/output interfaces. Input/output interfaces comprise serial and parallel data interfaces for printers, keyboards, pointing devices and the like, an rendering device, and a network interface for coupling the point-of-service workstation 220 to network 230. Back-office workstation 290, which may or may not be coupled to an image acquisition device, is configured similarly to point-of-service workstation 220.

Once image acquisition device 210 has acquired information representing an image of the source item 205, the acquired information is communicated to and temporarily stored in point-of-service workstation 220. Image acquisition device 210 can be operated via a device interface (not shown) or via one or more applications operative on workstation 220. A second client application operative on point-of-service workstation 220 and generally not associated image-acquisition applications that interface with image acquisition device 210, use a rendering device to generate interface 225 on a monitor communicatively coupled with computing device 300. The rendering device may comprise hardware and or software operative within computing device 300. The second client application renders one or more data elements such as data element 227 that include respective alphanumeric text strings.

Point-of-service workstation 220 is associated with an input device configured to provide a source identifier. The source identifier provides information about the acquired item. In some embodiments the image acquisition device may include logic for providing the information. In alternative embodiments, one or more of the operator interface devices can be used to communicate information about the acquired item. Regardless of the nature of the source of the information, point-of-service workstation 220 and or server 240 are configured with logic that associates a particular set of indexes with each item type provided by the system. For example, when an image of a driver's license is acquired by the image-acquisition device 210, a set of client configurable indexes are communicated to a screen scraper. The screen scraper in accordance with the set of indexes searches the rendered interface 225 for data elements associated with one or more of the indexes (i.e., members of the set) that are likely to be available on the rendered interface. For example, when the set of indexes includes the member “name,” the screen scraper responds by locating a string of text at an appropriate location on the rendered interface or by identifying information within the data stream used to generate the rendered interface that includes the client's name. Logic within point-of-service workstation 220 or within server 240 associates the extracted text with the member of the set. The resulting data element or populated data field is further associated or linked with the image information 255.

Server 240 is coupled in series between network 230 and data store 250 and controls the function and operation of data store 250. Point-of-service workstation 220 communicates with server 240 to forward or otherwise transfer image information 255 and set 270 for persistent storage in the data store 250. In the illustrated embodiment, set 270 includes index 272, index 274, through index 288. Each respective index is the combination of a member of a set and a populated data field. Specific sets, each associated with a respective source item type may have any number of members.

Once an index is populated with screen scraped information and associated with the corresponding image information 255, operators of point-of-service workstation 220, back-office workstation 290 or any other suitably configured device coupled to network 230 can retrieve image information 255 from data store 250 by entering a portion of any of the stored indexes, one or more complete indexes, or any combination thereof. When more than one image has been stored that meets the present search criteria entered by an operator, server 240 is configured to prompt the operator to either enter further information to use in querying the data store 250 or select one of the plurality of images that meet the search criteria.

The network 230 can be any local area network (LAN) a wide area network (WAN) or both a LAN and a WAN. When the network 230 is configured as a LAN, the LAN could be configured as a ring network, a bus network, and/or a wireless local network. When the network 230 takes the form of a WAN, the WAN could be the public-switched telephone network, a proprietary network, and/or the public access WAN commonly known as the Internet.

FIG. 3 is a block diagram illustrating an embodiment of the computing device 300 of FIG. 2. It should be appreciated that these same functional blocks may also be used to implement any of the other computing devices associated with the information processing system 200 of FIG. 2 (e.g., the server 240, the back-office workstation 290, and other computing devices (not shown)).

Generally, computing device 300 includes processor 310, memory 320, input/output interface 330, rendering device 340, and network interface 350 that are connected together and can communicate with each other via local interface 360. The local interface 360 can be, for example but not limited to, one or more buses or other wired or wireless connections, as is known in the art. The local interface 360 may have additional elements, which are omitted for simplicity, such as buffers (caches), drivers, and controllers, to enable communications. Further, the local interface 360 includes address, control, and data connections to enable appropriate communications among the aforementioned components.

The processor 310 is a hardware device for executing software that can be stored in the memory 320. The processor 310 can be any custom made or commercially available processor, a central processing unit (CPU) or an auxiliary processor among several processors associated with the computer, and a microchip based microprocessor. The memory 320 can include any one or a combination of volatile memory elements (e.g., random access memory (RAM), such as dynamic random-access memory (DRAM), static random-access memory (SRAM), etc.)) and nonvolatile memory elements (e.g., read-only memory (ROM), hard drive, tape, CD-ROM, etc.). Moreover, the memory 320 may incorporate electronic, magnetic, optical, and/or other types of storage media. Note that the memory 320 can have a distributed architecture, where various components are situated remote from one another, but can be accessed by the processor 310.

Memory 320 is configured with identifier logic 321, screen scraper 322, image acquisition application 323, editor 324, point-of-service application 327 and index logic 329, as well as a host of information stores including image information 255, source type store 326, and set store 325. Identifier logic 321 is configured to determine a source item type. In some embodiments, identifier logic 321 automatically makes a determination as to the source item by analyzing various attributes of the image information acquired by image acquisition device 210 (FIG. 2). In other embodiments, identifier logic 321 includes a table, list or other mechanism for associating an identifier with a specific source item type. As described above, source item types include questionnaire, medical card, government issued identification card, miscellaneous, among others. Regardless of the particular embodiment, identifier logic 321 retrieves and communicates a particular set in accordance with the source item type.

Screen scraper 322 is configured to identify and extract text information rendered and displayed on an output display device coupled to computing device 300. Screen scraper 322 may be configured to initiate a screen refresh and while the updated image information stream is being forwarded to a rendering device, the screen scraper 322 intercepts one or more parameters in textual format for use as an index or data value associated with said output display data displayed on the display device. Screen scraper 322 can also be configured to translate rendered information with respect to a reference point such that particular text information observable on the source item is accurately identified from the rendered and displayed representation of the source item. Regardless of which method is implemented to identify text information from the rendered representation of the source item, screen scraper 322 operates as directed by one or more sets each configured with one or more index values that can typically be observed on interface 225 (FIG. 2) as generated by interface logic 328 associated with point-of-service application 327.

Image acquisition application 323 is configured to acquire or otherwise receive image information that describes source item 205 (FIG. 2). Editor 324 is configured to enable an operator of computing device 300 to modify set 260, set 280, and/or various data values associated with set members (i.e., text information). In some embodiments, editor 324 is configured to enable an operator of computing device 300 to modify information associated with each acquired image. One or more of the screen scraper 322, image acquisition application 323, editor 324, and point-of-service application 327 or perhaps additional applications (not shown) are configured to associate one or more indexes with one or more representations of the source item. Computing device 300 then forwards both the index information and the image information 255 to data store 250 via network 230 and server 240, thus exposing the image information 255 in near real-time with operators of various computing devices coupled to network 230 with appropriate access privileges to the data store 250.

Thereafter, computing device 300 is configured to wait for screen scraper 322 to identify and provide the text information (i.e., data) associated with one or more members in the set associated with the source item type. Under some conditions, screen scraper 322 may locate and provide information for each member of the set. Under other conditions, screen scraper 322 may be unable to locate and provide data for each member of the set. When this is the case, index logic 329 is configured to prompt an operator of computing device 300 to enter as much information as is presently available to the operator. The operator enters the available information for members of the appropriate set.

In the illustrated embodiment, set store 325 is shown with set 260 and set 280. It should be understood that any number of sets can be configured and saved in set store 325. It should be further understood that a set is not limited to a plurality of members. That is, one or more additional sets (not shown) may include a single member. In some embodiments, set 260, set 280 and/or other sets (not shown) include additional information for directing screen scraper 322 where to locate specific information in the associated interface or where to locate specific information in the data stream that is directing rendering device 340.

As indicated in FIG. 3, set 260 includes member 262, member 264, and additional members through label 278. Set 260 identifies a plurality of members and associated fields, data for which is expected to be found in a particular interface such as interface 225 rendered on a display device in association with point-of-service application 327 in accordance with interface logic 328. Similarly, set 280 includes member 282, member 284, and additional members through member 288. Set 280 identifies a plurality of members and associated fields, data for which is expected to be found in interface 225 or in a separate interface (not shown) rendered on the display device in association with point-of-service application 327 or additional applications operable on workstation 220. In this regard, each of member 262, member 264, through member 278 and member 282, member 284, through member 288 may further include information (not shown) that identifies a location in a specific interface or a location in an information stream being forwarded to a rendering device where text information can be found to populate a data field associated with the respective member.

Editor 324 may be employed during a point-of-service quality check performed by an operator of the point-of-service workstation 220 after they have returned the representation of the source item to the client and otherwise dealt with the client.

Computing device 300 is integrated with input-output devices such as a keyboard and a mouse that communicate with computing device 300 via input/output interface(s) 330. In the illustrated embodiments, point-of-service workstation 220 is coupled with image-acquisition device 210, which communicates with computing device 300 via input/output interface(s) 330. Each of the various input devices are in communication with the processor 310 and/or the memory 320 via local interface 360 and the input/output interface(s) 330. Output devices may comprise a video signal interface that supplies a video output signal in accordance with rendering device 340 and a display monitor. A host of display monitor types may be associated with the various computing devices. The display monitor can be a conventional CRT based display device. Alternatively, the display monitor can be implemented with other display types, such as a liquid crystal display (LCD) or a plasma display. The output devices may also include a speaker as well as other well-known devices such as a printer.

Additional devices that communicate both inputs and outputs may be in communication with the local interface 360, for instance, but not limited to, a modulator/demodulator (modem; for accessing another device, system, or network), a radio frequency (RF) or other transceiver, a telephonic interface, a bridge, a router, etc. For simplicity of illustration, one example (i.e., network interface 350) of the above mentioned two-way communication devices are shown. Network interface 350, can be, for example, a network interface card that connects computing device 300 to network 230 (FIG. 2). Alternatively, network interface 350 could be a modulator/demodulator (modem) or any communication device capable of connecting computing device 300 to network 230. Note that in the case of the server 240 and the back-office workstation 290 and perhaps additional computing devices (not shown), the network interface 350 may be implemented via a network interface card suited for communications over the network 230.

The identifier logic 321, screen scraper 322, image-acquisition application 323, editor 324, point-of-service application 327 and index logic 329 in memory 320 may include one or more separate programs, each of which comprises an ordered listing of executable instructions for implementing logical functions. In the example of FIG. 3, the software in the memory 320 includes the above-mentioned items as well as a suitable operating system (not shown). The operating system essentially controls the execution of other computer programs, such as the point-of-service application 327 and provides scheduling; input-output control; file management; memory management communication control and related services.

The processor 310 and operating system define a computer platform, for which application programs, such as the identifier logic 321, screen scraper 322, image-acquisition application 323, editor 324, point-of-service application 327 and index logic 329, may be written in higher level programming languages. It will be appreciated that each of the various computing devices of FIG. 2 may be configured to run a host of applications substantially simultaneously using the aforementioned computer platform.

When the computing device 300 is in operation, the processor 310 is configured to execute software stored within the memory 320, to communicate data to and from the memory 320, and to generally control operations pursuant to the software. The identifier logic 321, screen scraper 322, image-acquisition application 323, editor 324, point-of-service application 327 and index logic 329, other applications, and the operating system, in whole or in part, but typically the latter, are read by the processor 310, perhaps buffered within the processor 310, and then executed.

The identifier logic 321, screen scraper 322, image-acquisition application 323, editor 324, point-of-service application 327 and index logic 329 can be implemented in software (e.g., firmware), hardware, or a combination thereof. In the currently contemplated best mode, the above-mentioned items are implemented in software, as an executable program, and are executed by a special or general purpose digital computer, such as a personal computer (PC; IBM-compatible, Apple-compatible, or otherwise), workstation, minicomputer, or mainframe computer as previously described.

The identifier logic 321, screen scraper 322, image-acquisition application 323, editor 324, point-of-service application 327 and index logic 329 are source programs, executable programs (object code), scripts, or any other entities comprising a set of instructions to be performed. When in the form of a source program, each of the programs are translated via a compiler, assembler, interpreter, or the like, which may or may not be included within the memory 320, so as to operate properly in connection with the operating system. Furthermore, identifier logic 321, screen scraper 322, image-acquisition application 323, editor 324, point-of-service application 327 and index logic 329 can be written in (a) an object oriented programming language, which has classes of data and methods, or (b) a procedure programming language, which has routines, subroutines, and/or functions.

Software components operable on the various workstations of the information processing system 200 comprise an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any mechanism or media that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a RAM, a ROM, an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

FIG. 4 is a flow diagram illustrating an embodiment of a method 400 for indexing image-based information that can be implemented by the information processing system 200 of FIG. 2. Functions within some of the blocks may be performed out of the order shown, and may also be performed in parallel. In block 402, a representation of a source item is acquired at a point-of-service. As described above, the source item can be a medical insurance card; a state issued identification card, such as a driver's license, a completed questionnaire, or any of a number of various forms that are desired to be integrated into the document management system. In block 404, a type responsive to the source item is identified. When the source item is a driver's license, the source type is a license. As described above, the identification can be performed automatically or in response to an operator input. When the source item is a medical insurance card, the source type is medical card. Other source types include questionnaires, bank drafts, and the like.

Thereafter, as indicated in block 406, a set including one or more members responsive to the type is identified. The set for a source item type of license might include members: number, birth date, name, address, sex, height, and weight. Whereas, the set for a source item type of medical insurance card might include members: identification number, group number, primary care physician, and the primary care physicians phone number. As indicated in block 408, an interface at the point-of-service is used to acquire information to populate a data field associated with a member of the set. In block 410, information in a populated data field is associated with the representation of the source item. The information in a populated data field is used to expose the source item to a user that communicates a query matching at least a portion of the information, as indicated in block 412. In block 414, the representation and information in a populated data field are forwarded to a location remote from the point-of-service. As described above, the remote location may be within a building or a suite of offices within a building or the remote location can be an Internet accessible data store.

In the illustrated embodiment the functionality associated with block 414 is optional. That is, in an alternative embodiment, the index information (i.e., the populated data fields) and image information can be stored on a workstation or other computing device coupled to an image-acquisition device. In embodiments that forwards the index information and the representation, the remote location may include a server and a data store that expose the representation to one or more back-office users of the document management system that communicate query information that matches at least a portion of one of the data fields associated with the representation, as indicated in block 412.

While various embodiments of the systems and methods for indexing image-based information have been described, it will be apparent to those of ordinary skill in the art that many more embodiments and implementations are possible that are within the scope of the systems and methods. Accordingly, the systems and methods for indexing image-based information are not to be restricted except in light of the attached claims and their equivalents.

What is claimed is:

1. A method for indexing image-based information in a document management system, the method comprising:
acquiring a representation of a source item at a point-of-service;
identifying a type responsive to the source item;
identifying a set including one or more members responsive to the type;
using an interface at the point-of-service to acquire information to populate a data field associated with a member of the set;
associating information in the data field with the representation; and
using the information to expose the source item to a user of the document management system that communicates a query matching at least a portion of the information.

2. The method of claim 1, further comprising:
forwarding the representation to the user.

3. The method of claim 2, further comprising:
storing the information and the representation in a data store.

4. The method of claim 3, wherein the data store is at a location remote from the point-of-service.

5. The method of claim 4, wherein the location remote from the point-of-service comprises a network coupled document store.

6. The method of claim 1, wherein the source comprises an identification card.

7. The method of claim 1, wherein the point-of-service comprises a medical facility.

8. The method of claim 7, wherein a medical service provider can controllably adjust data fields associated with one or more members of the set used to index the representation.

9. The method of claim 1, wherein using an interface at the point-of-service comprises screen scraping the interface.

10. The method of claim 9, wherein screen scraping comprises capturing specific text information rendered by the interface in response to the type.

11. The method of claim 10, wherein capturing specific text information comprises intercepting a data stream being forwarded to a rendering device.

12. The method of claim 10, wherein capturing specific text information comprises translating rendered information.

13. An information processing system, comprising:
an image acquisition device configured to generate a representation of a source item;
a workstation coupled to the image acquisition device, the workstation comprising:
an input device configured to provide a source identifier;
logic configured to retrieve a set responsive to the source identifier;
a rendering device configured to render an interface responsive to a point-of-service application;
a screen scraper configured to capture information from the interface, the information responsive to the set; and
logic configured to associate the information with the representation.

14. The information processing system of claim 13, further comprising:
a network interface configured to forward the representation and the information.

15. The information processing system of claim 13, further comprising:
a storage device configured to store the representation and the information and respond to a query that includes at least a partial match of the information.

16. The information processing system of claim 13, wherein the screen scraper looks for specific text information in the interface.

17. The information processing system of claim 13, wherein the input device provides the source identifier absent operator intervention.

18. The information processing system of claim 13, wherein the input device provides the source identifier in response to an operator.

19. The information processing system of claim 13, wherein an operator of the workstation controllably adjusts the information.

20. The information processing system of claim 13, wherein the image acquisition device acquires a representation of a source item at a point-of-service in response to a registration process.
